(19) United States
(12) Patent Application Publication
(10) Pub. No.: US 2021/0234967 A1
(43) Pub. Date: Jul. 29, 2021

(54) PRINTER AND CONTROL METHOD FOR PRINTER

(71) Applicant: SEIKO EPSON CORPORATION, Tokyo (JP)

(72) Inventor: Masaki KOBAYASHI, MATSUMOTO-SHI (JP)

(21) Appl. No.: 17/156,923

(22) Filed: Jan. 25, 2021

(30) Foreign Application Priority Data
Jan. 28, 2020 (JP) 2020-011415

(51) Int. Cl. H04N 1/00

(52) U.S. Cl. CPC H04N 1/00005; H04N 2201/0001; H04N 1/00015

(57) ABSTRACT

A printer includes a printing unit configured to perform printing on a printing medium having an elongated shape, a camera configured to capture a print image formed, by being printed by the printing unit, on the printing medium, a storage unit configured to store image data of the camera, and a winding unit configured to wind the printing medium on which printing was performed by the printing unit, and a contact sensor and a position detection sensor that detect a defect affecting a quality of the print image, in which the storage unit is configured to hold, when the defect affecting the quality of the print image is detected, the image data containing a unit print image formed by unit printing operation at a time when the defect affecting the quality of the print image is detected.

The present application is based on, and claims priority from JP Application Serial Number 2020-011415, filed Jan. 28, 2020, the disclosure of which is hereby incorporated by reference herein in its entirety.

### BACKGROUND

### 1. Technical Field

The present disclosure relates to a printer and a control method for the printer.

### 2. Related Art

For example, an image processing apparatus (printer) has been suggested in which a roll paper is used as a printing medium (JP 2016-10948 A).

The printer described in JP 2016-10948 A includes a print unit configured to perform printing on a roll paper, and a reading unit configured to read a printing surface of the roll paper. On the printing surface of the roll paper, a print failure detection pattern for determining whether a printing is properly performed is formed so as to avoid overlapping a print material. The reading unit is configured to compare, after reading the print failure detection pattern, the print failure detection pattern having been read with reference data (print failure detection pattern data) and to thus determine whether the printing is properly performed. When it is determined that the printing has failed, the print material located between the print failure detection pattern and a print failure detection pattern to be printed next is determined to have failed in the printing.

Unfortunately, because the printer described in JP 2016-10948 A does not directly evaluate the print material, there is a risk that a print material of an acceptable quality is erroneously determined to have failed in the printing, and that a print material of an unacceptable quality is erroneously determined to have been successful in printing.

### SUMMARY

A printer includes a printing unit configured to perform printing on a printing medium having an elongated shape, an image-capturing unit configured to capture a print image formed, by being printed by the printing unit, on the printing medium, a storage unit configured to store image data of the image-capturing unit, and a winding unit configured to wind the printing medium on which printing was performed by the printing unit, and a detection unit configured to detect a defect affecting a quality of the print image, in which the storage unit is configured to hold, when the defect is detected, the image data containing a unit print image formed by unit printing operation at a time when the defect is detected.

A control method for a printer includes capturing a print image formed on a printing medium having an elongated shape, detecting a defect affecting a quality of the print image, and causing the storage unit to hold, when the defect is detected, the image data containing a unit print image formed by unit printing operation at a time when the defect is detected.

### BRIEF DESCRIPTION OF THE DRAWINGS

FIG. 1 is a view schematically illustrating a configuration of a printer according to an embodiment.

FIG. 2 is a plan view illustrating a state of a nozzle formation face of a liquid discharge head.

FIG. 3 is a diagram schematically illustrating a state of a print image formed on a printing medium.

FIG. 4 is a block diagram illustrating an electrical configuration of a printer according to an embodiment.

FIG. 5 is a diagram schematically illustrating a state of a screen displayed on an operation unit.

FIG. 6 is a diagram schematically illustrating a state of another screen displayed on an operation unit.

### DESCRIPTION OF EXEMPLARY EMBODIMENTS

### 1. Embodiment

### Overview of Printer

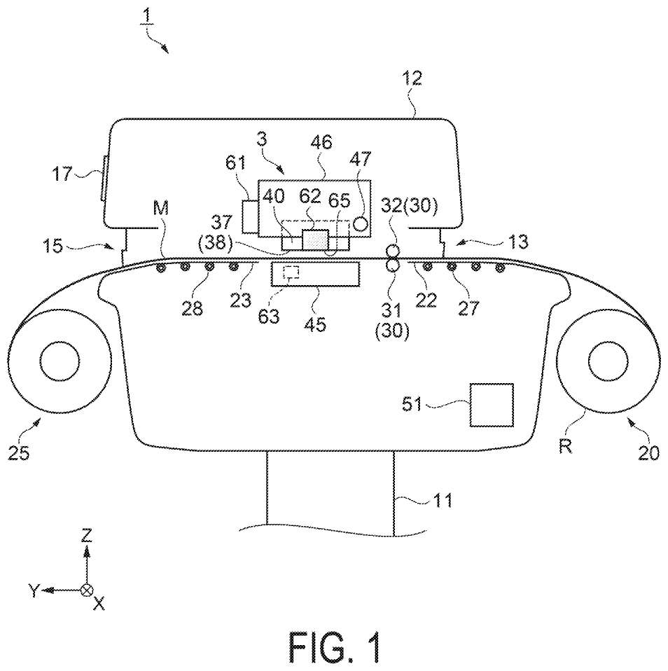

As illustrated in FIG. 1, a printer 1 according to the embodiment is a large format printer configured to handle a printing medium M having an elongated shape. The printer 1 includes a leg portion 11, a housing unit 12 supported by the leg portion 11, a set unit 20 and a winding unit 25 that are attached to both ends of the housing unit 12, and an operation unit 17 attached to one of the ends of the housing unit 12. As the printing medium M, high-quality paper, cast coated paper, art paper, coat paper, synthetic paper, or a film composed of polyethylene terephthalate (PET), polypropylene (PP), or the like can be used, for example.

In the following description, a width direction of the printer 1 (a width direction of the printing medium M) is designated as an X direction, a height direction of the printer 1 is designated as a Z direction, and a depth direction intersecting the X direction and the Z direction is designated as a Y direction. Further, a leading-end side of an arrow indicating a direction is defined as a+direction, and a base-end side of the arrow indicating the direction is defined as a−direction.

Note that the +X direction and the −X direction (the width direction of the printing medium M) are an example of a scanning direction in this application, and is hereinafter referred to as a scanning direction X. The +Y direction is an example of a direction intersecting the scanning direction in this application, and is hereinafter referred to as a transport direction Y.

A printing unit 3 configured to perform printing on the printing medium M having an elongated shape is provided inside the housing unit 12. The printing unit 3 includes a carriage 46 movable in the scanning direction X, a liquid discharge head 40 mounted on the carriage 46 and configured to discharge a liquid onto the printing medium M, a transport unit 30 configured to transport the printing medium M in a direction intersecting the scanning direction X (the transport direction Y), and a platen 45 disposed facing a nozzle formation face 38 at which a nozzle 37 of the liquid discharge head 40 is formed.

In addition to the liquid discharge head 40, the carriage 46 is equipped with a camera 61 and a contact sensor 62. A position detection sensor 63 is attached to the platen 45.

Note that the camera 61 is an example of an image-capturing unit in this application. Also, the embodiment has a configuration in which the camera 61 that is an example of the image-capturing unit is mounted on the carriage 46.

An upstream medium support unit 22 is disposed upstream in the transport direction Y of the platen 45, and a downstream medium support unit 23 is disposed downstream in the transport direction Y of the platen 45. The printing medium M having an elongated shape is transported, while being supported by the upstream medium support unit 22, the platen 45, and the downstream medium support unit 23, by the transport unit 30 in a direction (the transport direction Y) from the upstream medium support unit 22 toward the downstream medium support unit 23.

The printing medium M is unwound from a roll body R stored in the set unit 20 to be fed, through a feeding port 13, to an inside of the housing unit 12. The printing medium M fed from the set unit 20 is guided, while being supported by the upstream medium support unit 22, to the transport unit 30. The printing medium M guided to the transport unit 30 is transported by the transport unit 30 toward the liquid discharge head 40 (the platen 45).

The liquid discharge head 40 discharges, in a state where the printing medium M is supported by the platen 45, a liquid onto a front face of the printing medium M to form a print image on the printing medium M The printing medium M on which the print image is formed is ejected, while being supported by the downstream medium support unit 23, through an ejection port 15 to an outside of the housing unit 12, to be wound by the winding unit 25 into a rolled form. That is, the winding unit 25 is configured to wind the printing medium M on which printing was performed by the printing unit 3.

A heater 27 is attached to the upstream medium support unit 22, a heater 28 is attached to the downstream medium support unit 23, and, although not illustrated, a heater is also attached to the platen 45. The heaters 27 and 28 are tube heaters, for example.

In order to promptly dry the liquid discharged onto the printing medium M, the platen 45 is heated from a room temperature to a predetermined temperature by the heater. The heater 27 is configured to gradually heat the temperature of the printing medium M from the room temperature to the predetermined temperature via the upstream medium support unit 22. The heater 28 is configured to heat the temperature of the printing medium M to a temperature greater than the predetermined temperature via the downstream medium support unit 23, and to dry the liquid discharged onto the printing medium M before the printing medium M is wound around the winding unit 25.

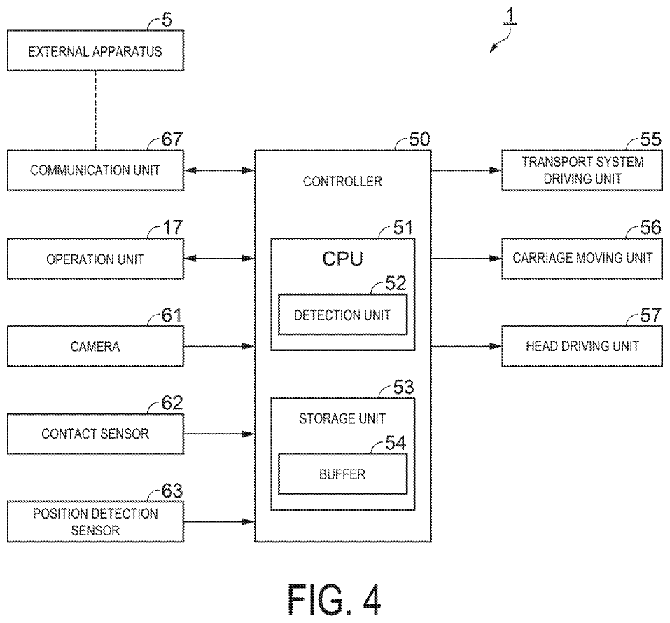

The transport unit 30 is disposed upstream in the transport direction Y of the liquid discharge head 40, and includes a driving roller 31 and a driven roller 32. The driven roller 32 is pressed, via the printing medium M, against a driving roller 21, and is rotationally driven. The driving roller 31 pinches the printing medium M together with the driven roller 32. The driving roller 31 is rotationally driven by a transport system driving unit 55 (see FIG. 4) that will be described later to thus transport the printing medium M in the transport direction Y.

The operation unit 17 is constituted by a liquid crystal display apparatus that includes a touch panel, for example. An operator is allowed to perform various settings of the printer 1 through the operation unit 17.

The carriage 46 is supported by a guide shaft 47 extending in the scanning direction X, and is movable in a direction (the scanning direction X) in which the guide shaft 47 extends. The liquid discharge head 40, the camera 61, and the contact sensor 62 that are mounted on the carriage 46 are movable together with the carriage 46 in the scanning direction X.

The camera 61 is disposed downstream in the transport direction Y of the liquid discharge head 40. Note that the camera 61 may be disposed in the scanning direction X with respect to the liquid discharge head 40.

The camera 61 includes a plurality of imaging elements (not illustrated) aligned in the transport direction Y and the scanning direction X, an optical system (not illustrated), and a cover (not illustrated) that protects the imaging elements and the optical system. The camera 61 is configured to capture the print image formed, by being printed by the printing unit 3, on the printing medium M.

For the imaging element, an element that converts light into an electrical signal, such as a charge coupled device (CCD) image sensor or a complementary metal oxide semiconductor (CMOS) image sensor, is used. The cover protects the imaging element and the optical system so as to prevent mist of a liquid discharged from the nozzle 37 from adhering to the imaging element or the optical system.

The contact sensor 62 is constituted by a piezoelectric film or the like, and is installed at two locations on a side in the +X direction and a side in the −X direction with the liquid discharge head 40 interposed therebetween. A detection face 65 of the contact sensor 62 is disposed at the same height as the nozzle formation face 38 of the liquid discharge head 40.

For example, when localized irregularities occur on the printing medium M, the nozzle formation face 38 of the liquid discharge head 40 may make contact with the printing medium M. When the liquid discharge head 40 makes contact with the printing medium M, the print image formed on the printing medium M is rubbed by the liquid discharge head 40.

Because the detection face 65 of the contact sensor 62 is disposed at the same height as the nozzle formation face 38 of the liquid discharge head 40, the liquid discharge head 40 makes contact with the printing medium M when the printing medium M makes contact with the detection face 65 of the contact sensor 62, and the printing medium M is then rubbed by the liquid discharge head 40.

An occurrence of the rubbing by the liquid discharge head 40 may change a state of the print image formed on the printing medium M to alter a quality of the print image. The occurrence of the rubbing by the liquid discharge head 40 may cause mist of a liquid adhering to the nozzle formation face 38 of the liquid discharge head 40 to be transferred to the print image, to contaminate the print image, altering the quality of the print image.

Note that an acceptable level of the quality of the print image varies depending on a user to which the printing medium M (print material) on which the print image is formed is provided. For example, because there may be a case where a minor state change or a minor contamination is acceptable or a case where the minor state change or the minor contamination is unacceptable, there may be a case where the print material having been rubbed by the liquid discharge head 40 is of a quality that is acceptable to the user or of a quality that is unacceptable to the user.

Accordingly, the rubbing by the liquid discharge head 40 is not an accident where the print image formed on the printing medium M is assumed to be a failed image, but an occurrence (defect) affecting the quality of the print image formed on the printing medium M.

In the printer 1, a detection unit 52 (see FIG. 4) that will be described later detects, based on a signal from the contact sensor 62, the occurrence (defect) affecting the quality of the print image, which is the rubbing by the liquid discharge head 40. Accordingly, the contact sensor 62 and the detection unit 52, which correspond to a detection unit in this application, detect a defect (the rubbing by the liquid discharge head 40) affecting the quality of the print image.

The position detection sensor 63 attached to the platen 45 includes an irradiation unit configured to irradiate with light, and a detection unit configured to detect the light. In the position detection sensor 63, the irradiation unit irradiates, with the light, a back face of the printing medium M, and the detection unit detects reflected light reflected by the back face of the printing medium M.

In the printer 1, the detection unit 52 detects, based on a signal from the position detection sensor 63, fluctuations in a transport amount of the printing medium M.

For example, the fluctuations in the transport amount of the printing medium M cause banding such as streak, color irregularity, and the like to occur in the print image formed on the printing medium M, which may alter the quality of the print image.

The print material in which the fluctuations in the transport amount of the printing medium M have occurred may be of a quality that is acceptable to the user or of a quality that is unacceptable to the user, as in the print material having been rubbed by the liquid discharge head 40. Accordingly, the fluctuations in the transport amount of the printing medium M are not the accident where the print image formed on the printing medium M is assumed to be a failed image, but the occurrence (defect) affecting the quality of the print image formed on the printing medium M, as in the rubbing by the liquid discharge head 40.

The detection unit 52 is configured to detect, based on the signal from the position detection sensor 63, the occurrence (defect) affecting the quality of the print image, the occurrence being the fluctuations in the transport amount of the printing medium M. Accordingly, the position detection sensor 63 and the detection unit 52, which correspond to the detection unit in this application, detect the defect (the fluctuations in the transport amount of the printing medium M) affecting the quality of the print image.

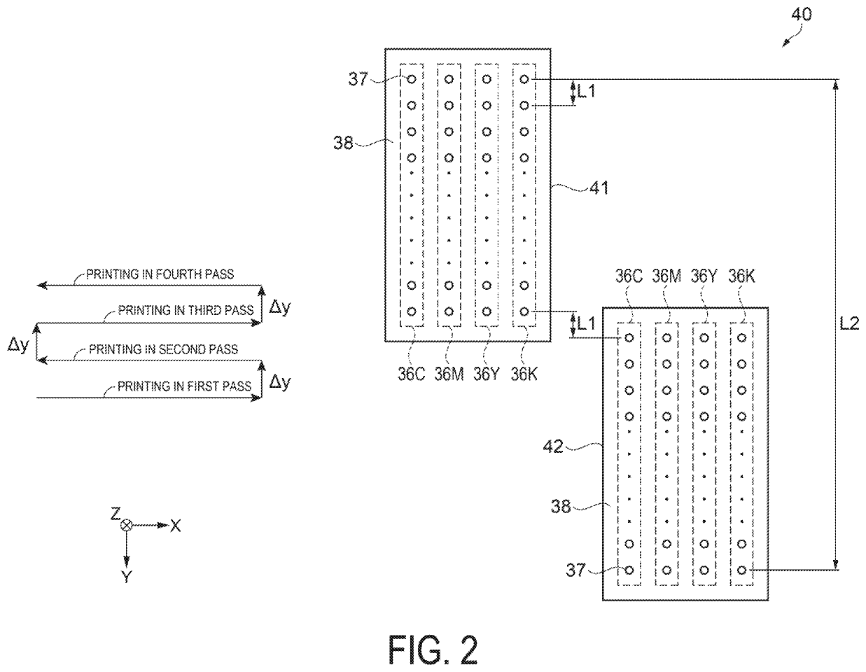

As illustrated in FIG. 2, the liquid discharge head 40 includes a first head 41 disposed upstream in the transport direction Y, and a second head 42 disposed downstream in the transport direction Y.

The first head 41 and the second head 42 have nozzle rows 36C, 36M, 36Y, and 36K in each of which the nozzles 37 that discharge a liquid are aligned. Specifically, in the first head 41 and the second head 42, the nozzle row 36C that discharges a liquid of cyan (C), the nozzle row 36M that discharges a liquid of magenta (M), the nozzle row 36Y that discharges a liquid of yellow (Y), and the nozzle row 36K that discharges a liquid of black (K) are arranged along the scanning direction X.

The heads 41 and 42 are components manufactured by integrating, by a semiconductor manufacturing technology, a common liquid chamber (not illustrated), a pressure generation chamber (not illustrated), a piezoelectric element (not illustrated), the nozzle 37, and the like. The nozzle 37 is formed on the nozzle formation face 38 of the heads 41 and 42, and is disposed facing the printing medium M (the platen 45). The piezoelectric element is a piezoelectric actuator in a deflection vibration mode, or a piezoelectric actuator in a vertical vibration mode. In the heads 41 and 42, the piezoelectric element is configured to vibrate, in a state where a liquid is supplied, via the common liquid chamber, to the pressure generation chamber, a diaphragm forming a part of the pressure generation chamber, and causes pressure fluctuations to occur in the pressure generation chamber. The pressure fluctuations are used to discharge the liquid from the nozzle 37 onto the printing medium M.

In the heads 41 and 42, the piezoelectric element is driven based on a voltage supplied from a head driving unit 57 (see FIG. 4) that will be described later, and the liquid is discharged from the nozzle 37 onto the printing medium M.

The nozzles 37 are arranged at constant intervals in each of the first head 41 and the second head 42, when viewed in the scanning direction X. The interval between the nozzles 37 in the heads 41 and 42 is L1. Moreover, the interval between the nozzles 37 arranged at an end in the +Y direction of a nozzle row of the first head 41 and the nozzles 37 arranged at an end in the −Y direction of a nozzle row of the second head 42 is equal to the interval between the nozzles 37 in the heads 41 and 42, where the intervals are equally L1, when viewed in the scanning direction X.

In addition, a distance between the nozzles 37 arranged at an end in the −Y direction of the nozzle row of the first head 41 and the nozzles 37 arranged at an end in the +Y direction of the nozzle row of the second head 42 is L2, when viewed in the scanning direction X.

Such a configuration allows the liquid discharge head 40 to be regarded as an elongated head at which a plurality of the nozzles 37 are arranged at the intervals of L1 within the distance of L2.

The printer 1 alternately repeats an operation of discharging a liquid onto the printing medium M while moving the liquid discharge head 40 (the heads 41 and 42) in the scanning direction X, and a line break operation in which the liquid discharge head 40 (the heads 41 and 42) is relatively moved relative to the printing medium M, to thus form the print image containing characters, graphics, and the like on the printing medium M.

In the following description, one-time main scanning in which the liquid discharge head 40 (the heads 41 and 42) moves in the scanning direction X while discharging a liquid is referred to as a pass.

As illustrated in FIG. 2, the printer 1 performs a main scanning in which the liquid discharge head 40 is one-time moved in the +X direction of the scanning direction X, to perform a printing in a first pass. Upon termination of the printing in the first pass, the printer 1 performs a line break (sub scanning) in which the printing medium M is moved in the transport direction Y by a line break amount Δy and the liquid discharge head 40 is relatively moved relative to the printing medium M by the line break amount Δy, to then dispose the liquid discharge head 40 at the next start position of the main scanning. Subsequently, from the position, the printer 1 performs the main scanning in which the liquid discharge head 40 is one-time moved in the −X direction of the scanning direction X, to then perform a printing in a second pass. Upon termination of the printing in the second pass, the printer 1 performs the sub scanning in which the liquid discharge head 40 is relatively moved by the line break amount Δy relative to the printing medium M, to then dispose the liquid discharge head 40 at the next start position of the main scanning. Subsequently, from the position, the printer 1 performs the main scanning in which the liquid discharge head 40 is one-time moved in the +X direction of the scanning direction X, to then perform the printing in a third pass. Upon termination of the printing in the third pass, the printer 1 performs the sub scanning in which the liquid discharge head 40 is relatively moved by the line break amount Δy relative to the printing medium M, to then dispose the liquid discharge head 40 at the next start position of the main scanning. Subsequently, from the position, the printer 1 performs the main scanning in which the liquid discharge head 40 is one-time moved in the −X direction of the scanning direction X, to then perform the printing in a fourth pass.

As such, the printer 1 alternately repeats the main scanning in which a liquid is discharged onto the printing medium M while moving the liquid discharge head 40 in the scanning direction X, and the sub scanning in which the liquid discharge head 40 is relatively moved relative to the printing medium M, to thus form the print image on the printing medium M.

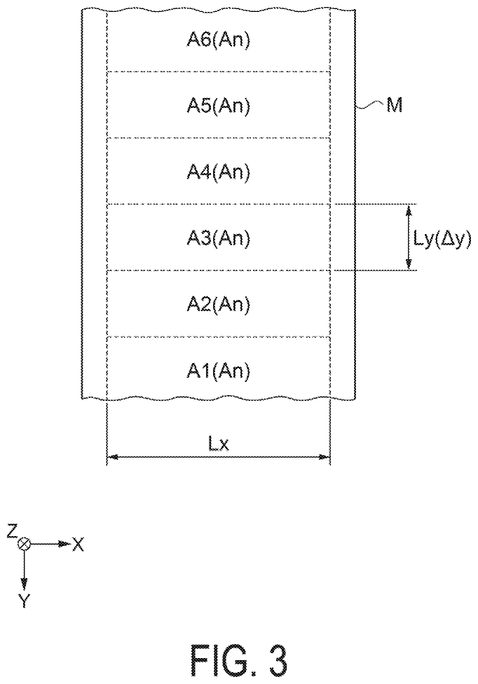

As illustrated in FIG. 3, the printer 1 alternately repeats the main scanning and the sub scanning, to thus sequentially form a unit print image A1, a unit print image A2, a unit print image A3, a unit print image A4, a unit print image A5, and a unit print image A6 in a direction opposite to the transport direction Y (the −Y direction), to thus form the print image on the printing medium M. In other words, the unit print images An are aligned in the direction opposite to the transport direction Y, to thus form the print image on the printing medium M.

A dimension Lx in the scanning direction X of the unit print images An is a movement distance of the liquid discharge head 40 in the main scanning. A dimension Ly in the transport direction Y of the unit print image An is a dimension of the distance of L2 described above plus the interval of L1.

In the embodiment, the line break operation (the sub scanning) is performed in which the liquid discharge head 40 is relatively moved relative to the printing medium M, such that the line break amount Δy in the sub scanning coincides with the dimension Ly in the transport direction Y of the unit print image An. For example, as illustrated in FIG. 2, the unit print image A1 is formed by the printing in the first pass, the unit print image A2 is formed by the printing in the second pass, the unit print image A3 is formed by the printing in the third pass, and the unit print image A4 is formed by the printing in the fourth pass.

In the embodiment, one-time main scanning and one-time sub scanning are performed to form the unit print image An on the printing medium M. In this case, the one-time main scanning and one-time sub scanning correspond to unit printing operation that forms the unit print image An. Specifically, the line break operation (the one-time sub scanning) in which the liquid discharge head 40 is relatively moved relative to the printing medium M, and the operation (the one-time main scanning) that is subsequently performed, in which a liquid is discharged onto the printing medium M while the liquid discharge head 40 is being moved in the scanning direction X, correspond to the unit printing operation that forms the unit print image An.

The printer 1 then repeats the unit printing operation consisting of the one-time main scanning and one-time sub scanning, and aligns the unit print images An in the direction opposite to the transport direction Y, to form the print image on the printing medium M.

Note that a configuration may be employed in which the line break amount Δy in the sub scanning is 1/m of the dimension Ly in the transport direction Y of the unit print image An, without being limited to the configuration in which the line break amount Δy in the sub scanning is the dimension Ly in the transport direction Y of the unit print image An.

For example, the line break amount Δy in the sub scanning may be ¼ of the dimension Ly in the transport direction Y of the unit print image An. In this case, the printer 1 repeats the one-time main scanning and the one-time sub scanning four times to form the unit print image An. In this case, the four-times main scanning and four-times sub scanning correspond to the unit printing operation that forms the unit print image An.

For example, the line break amount Δy in the sub scanning may be 1/12 of the dimension Ly in the transport direction Y of the unit print image An. In this case, the printer 1 repeats the one-time main scanning and the one-time sub scanning 12 times to form the unit print image An. In this case, the 12-times main scanning and 12-times sub scanning correspond to the unit printing operation that forms the unit print image An.

As illustrated in FIG. 4, the printer 1 according to the embodiment includes a controller 50, the transport system driving unit 55, a carriage driving unit 56, the head driving unit 57, a communication unit 67, the operation unit 17, the camera 61, the contact sensor 62, and the position detection sensor 63.

The controller 50 includes a CPU 51 that functions as a control unit configured to control the printer 1, and a storage unit 53 configured to store image data of the camera 61. The CPU 51 is coupled, via a system bus, to the storage unit 53.

The CPU 51 is a processing device that is configured to overall control the printer 1. The CPU 51 includes the detection unit 52.

The storage unit 53 is constituted by a storage element such as a RAM or a ROM, a hard disk, and the like. The storage unit 53 stores a program for operating the CPU 51, an arithmetic result of the CPU 51, the image data captured by the camera 61, and the like. The storage unit 53 is further provided with a buffer 54 in which the image data captured by the camera 61 is temporarily stored.

In the liquid discharge head 40, the piezoelectric element is driven to cause the diaphragm to vibrate, and the piezoelectric element is stopped being driven to cause the diaphragm to stop vibrating. Moreover, when the piezoelectric element is stopped being driven, a residual vibration occurs without causing the diaphragm to immediately stop vibrating.

The detection unit 52 is configured to observe a signal waveform according to the residual vibration output from the piezoelectric element, to detect a liquid discharge failure.

Note that the liquid discharge failure includes a defect in which an excess liquid is discharged from the nozzle 37 and a defect in which air bubbles mixed inside the liquid discharge head 40 or a viscosity increased liquid prevent the liquid from being discharged from the nozzle 37.

The print material in which the liquid discharge failure has occurred may be of a quality that is acceptable to the user or may be of a quality that is unacceptable to the user, as in the print material in which the fluctuations in the transport amount of the printing medium M have occurred and the print material having been rubbed by the liquid discharge head 40. Thus, the liquid discharge failure is not the accident where the print image formed on the printing medium M is assumed to be a failed image, but the occurrence (defect) affecting the quality of the print image formed on the printing medium M, as in the fluctuations in the transport amount of the printing medium M and the rubbing by the liquid discharge head 40. medium m is a failed image.

As such, the detection unit 52 is configured to detect the defect (the liquid discharge failure) affecting the quality of the print image, based on the signal waveform according to the residual vibration output from the piezoelectric element.

The CPU 51 is coupled to the operation unit 17, and is configured to receive information input to the operation unit 17. The operation unit 17 is constituted by a liquid crystal display apparatus including a touch panel, for example.

The CPU 51 is connectable, via the communication unit 67, to an external apparatus 5. The external apparatus 5 is a personal computer or the like, and is a portable information device such as a tablet terminal or a smartphone, which is portable by the operator, for example.

The CPU 51 is configured to form the print image on the printing medium M based on print information input from the operation unit 17 and print information from the external apparatus 5.

The CPU 51 is coupled with the transport system driving unit 55 such as an electric motor that drives the transport unit 30, the carriage driving unit 56 such as an electric motor that drives the carriage 46, and the head driving unit 57 that drives the liquid discharge head 40 (the heads 41 and 42).

The transport system driving unit 55 is configured, based on a control of the CPU 51, to rotate, or stop the rotation of the driving roller 31 of the transport unit 30. The carriage driving unit 56 is configured, based on the control of the CPU 51, to move, along the guide shaft 47, the carriage 46 that is driven and coupled via a pulley or endless belt, and to stop moving the carriage 46. The head driving unit 57 is configured, based on the control of the CPU 51, to apply a voltage to the piezoelectric element that is driven when the liquid discharge head 40 discharges a liquid, and to stop applying the voltage.

The CPU 51 is coupled to the camera 61 to acquire the image data captured by the camera 61, and is configured to temporarily hold the image data in the buffer 54 of the storage unit 53.

The buffer 54 is configured to hold the image data captured by the camera 61 for a certain period of time. The storage unit 53 stores the image data captured by the camera 61, among the image data that are temporarily held in the buffer 54, and the remaining image data are rewritten to new image data, at the time when the detection unit 52 detects the defect affecting the quality of the print image.

That is, the image data that are related to the defect affecting the quality of the print image, among the image data captured by the camera 61, are stored in the storage unit 53, while the image data that are not related to the defect affecting the quality of the print image are discarded.

The storage unit 53 is configured to store only the image data that are related to the defect affecting the quality of the print image, thus reducing a storage capacity of the storage unit 53 compared to when all of the image data captured by the camera 61 are stored.

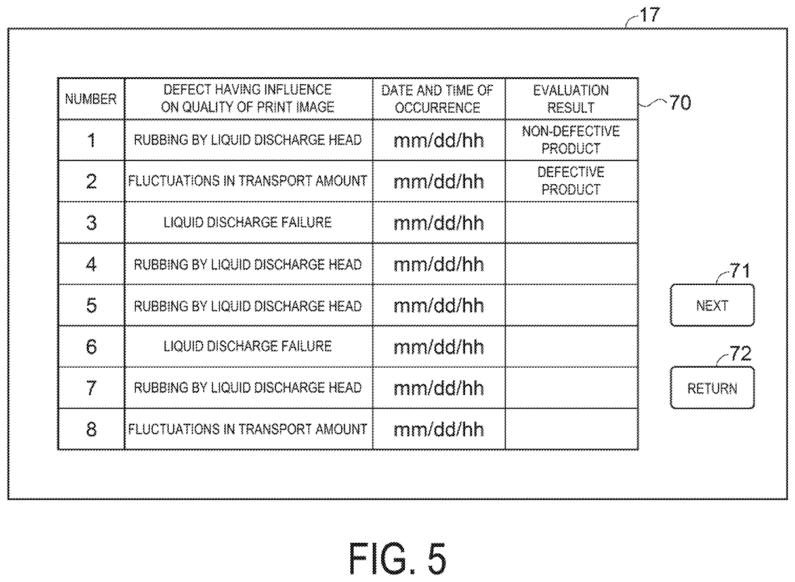

The storage unit 53 is configured, when the detection unit 52 detects the defect affecting the quality of the print image, to register (hold) a content of the defect affecting the quality of the print image. The operation unit 17 displays, as a list screen 70, the content of the defect affecting the quality of the print image, which is registered in the storage unit 53 (see FIG. 5).

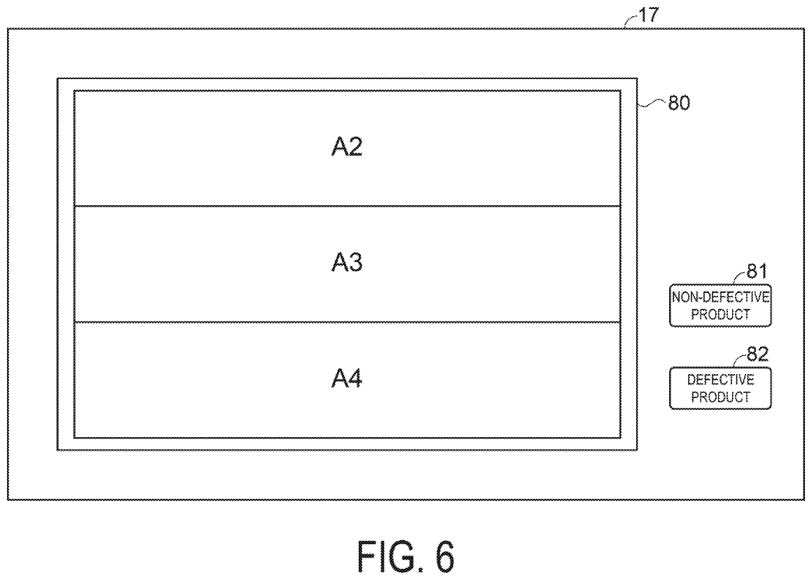

When the operator selects a defect affecting a quality within the list screen 70 displayed on the operation unit 17, the operation unit 17 displays, as a test screen 80, the image data related to the defect affecting the quality (see FIG. 6).

Control Method for Printer

The control method for the printer 1 according to the embodiment includes the steps for capturing, by the camera 61, a print image formed on the printing medium M having an elongated shape (step S1), detecting, by the detection unit 52, the contact sensor 62, and the position detection sensor 63, the defect affecting the quality of the print image formed on the printing medium M (step S2), and causing the storage unit 53 to hold, when the defect affecting the quality of the print image is detected, the image data containing the unit print image An formed by the unit printing operation at the time when the defect is detected (step S3).

In other words, the control method for the printer 1 according to the embodiment includes capturing the print image formed on the printing medium M having an elongated shape, detecting the defect affecting the quality of the print image, and causing the storage unit 53 to hold, when the defect is detected, the image data containing the unit print image An formed by the unit printing operation at the time when the defect is detected.

In step S1, the camera 61 captures the print image formed on the printing medium M having an elongated shape. Specifically, the camera 61 captures each of the unit print images An formed on the printing medium M having an elongated shape, to create the image data. The image data captured by the camera 61 is temporarily stored in the buffer 54.

In step S2, the detection unit 52 detects, based on a signal from the contact sensor 62, the rubbing by the liquid discharge head 40, which is a defect affecting the quality of the print image. The detection unit 52 further detects, based on a signal from the position detection sensor 63, the fluctuations in the transport amount of the printing medium M, which are the defect affecting the quality of the print image. The detection unit 52 further detects, based on the signal waveform according to the residual vibration output from the piezoelectric element, the liquid discharge failure that is the defect affecting the quality of the print image.

In step S3, the CPU 51, when the detection unit 52 detects the defect affecting the quality of the print image, causes the storage unit 53 to hold the image data containing the unit print image An formed at the time when the defect is detected. That is, the CPU 51 causes the storage unit 53 to hold the image data containing the unit print image An formed at the time when the defect affecting the quality of the print image is detected, among the image data temporarily stored in the buffer 54.

As such, the embodiment has a configuration in which the storage unit 53 is caused to hold, when the defect affecting the quality of the print image is detected, the image data containing the unit print image An formed by the unit printing operation at the time when the defect is detected.

In the following description, it is assumed that the unit print image An formed by the unit printing operation at the time when the defect affecting the quality of the print image is detected is the unit print image A3 illustrated in FIG. 3. It is further assumed that an immediately preceding unit print image An−1 formed by unit printing operation immediately before the unit printing operation at the time when the defect affecting the quality of the print image is detected is the unit print image A2 illustrated in FIG. 3. It is further assumed that an immediately succeeding unit print image An+1 formed by unit printing operation immediately after the unit printing operation at the time when the defect affecting the quality of the print image is detected is the unit print image A4 illustrated in FIG. 3.

Further, in the following description, the unit print image A3 formed by the unit printing operation at a time when the defect affecting the quality of the print image is detected is referred to as the unit print image A3 in which the defect has occurred. Further, the unit print image A2 formed by unit printing operation immediately before the unit printing operation at the time when the defect affecting the quality of the print image is detected is referred to as an immediately preceding unit print image A2. Further, the unit print image A4 formed by unit printing operation immediately after the unit printing operation is detected at the time when the defect affecting the quality of the print image is detected is referred to as an immediately succeeding unit print image A4.

In the embodiment, the CPU 51 causes the storage unit 53 to hold the image data containing the immediately preceding unit print image A2 and the immediately succeeding unit print image A4, in addition to the unit print image A3 in which the defect has occurred.

Note that the CPU 51 may cause the storage unit 53 to hold, as the image data, only the unit print image A3 in which the defect has occurred.

The CPU 51 may further cause the storage unit 53 to hold the image data containing the immediately preceding unit print image A2, in addition to the unit print image A3 in which the defect has occurred. The CPU 51 may further cause the storage unit 53 to hold the image data containing the immediately succeeding unit print image A4, in addition to the unit print image A3 in which the defect has occurred.

That is, a configuration may be employed in which the storage unit 53 holds, when the defect affecting the quality of the print image is detected, the image data containing at least one of the immediately preceding unit print image A2 formed by unit printing operation immediately before the unit printing operation at the time when the defect is detected, or the immediately succeeding unit print image A4 formed by unit printing operation immediately after the unit printing operation at the time when the defect is detected, in addition to the unit print image A3 formed by the unit printing operation at the time when the defect is detected.

A length of the printing medium M unwound from the roll body R stored in the set unit 20 may range over several hundred meters. For example, when the length of the printing medium M in an elongated form is several hundred meters, the printer 1 is continuously operated even at night when the operator is absent, to continuously form the print image on the printing medium M in an elongated form.

The CPU 51, while the printer 1 is continuously operated for a long period of time, causes the storage unit 53 to hold the content of the defect affecting the quality of the print image (the rubbing by the liquid discharge head 40, the fluctuations in the transport amount of the printing medium M, and the liquid discharge failure), and a date and time when the defect affecting the quality of the print image occurred.

As illustrated in FIG. 5, upon termination of the continuous operation for a long period of time of the printer 1, the operation unit 17 displays, as the list screen 70, a number given in the order that the defect affecting the quality occurred, the defect affecting the quality, the date and time when the defect affecting the quality occurred, and an evaluation result by the operator. The operation unit 17 further displays, in addition to the list screen 70, an icon 71 that proceeds to the succeeding list screen 70 and an icon 72 that returns to the preceding list screen 70.

In addition, the list screen 70 illustrated in FIG. 5 resisters an evaluation result of number 1 as a non-defective product, and an evaluation result of number 2 as a defective product.

Upon termination of the continuous operation for a long period of time of the printer 1, the operator selects the defect affecting the quality, which is displayed on the list screen 70. For example, the operator selects the defect (the liquid discharge failure) of number 3. The operation unit 17 then displays the test screen 80 illustrated in FIG. 6. Specifically, the operation unit 17 displays an icon 81 of a non-defective product and an icon 82 of a defective product, in addition to the test screen 80.

Because the storage unit 53 holds the image data containing the immediately preceding unit print image A2 and the immediately succeeding unit print image A4 in addition to the unit print image A3 in which the defect has occurred, the test screen 80 displays the immediately preceding unit print image A2, the unit print image A3 in which the defect has occurred, and the immediately succeeding unit print image A4, as illustrated in FIG. 6.

Because the defect affecting the quality has not occurred in the immediately preceding unit print image A2 and the immediately succeeding unit print image A4, the immediately preceding unit print image A2 and the immediately succeeding unit print image A4 that are displayed on the test screen 80 have no quality issues and are the non-defective products.

The operator views the unit print image A3 in which the defect has occurred in comparison with the unit print images A2 and A4 to evaluate the quality of the unit print image A3 in which the defect has occurred, and to evaluate whether the unit print image A3 in which the defect has occurred is the defective product or the non-defective product.

The operator, upon evaluating that the unit print image A3 in which the defect has occurred is the non-defective product, selects the icon 81 of a non-defective product, and upon evaluating that the unit print image A3 in which the defect has occurred is the defective product, selects the icon 81 of a defective product. Then, a screen displayed on the operation unit 17 is switched from the test screen 80 to the list screen 70, and the evaluation result of the operator is registered in the evaluation result on the list screen 70.

In the embodiment, the operator, who views the unit print image A3 in which the defect has occurred in comparison with the unit print images A2 and A4 of non-defective product to evaluate the quality of the unit print image A3 in which the defect has occurred, can more properly evaluate the quality of the unit print image A3 in which the defect has occurred than when viewing only the unit print image A3 in which the defect has occurred to evaluate the quality of the unit print image A3 in which the defect has occurred.

The operator repeats an operation of selecting the defect affecting the quality from the list screen 70, and an operation of viewing the image data of the unit print image An in which the defect has occurred from the test screen 80 to evaluate the quality of the unit print images An in which the defect has occurred, to evaluate the quality of all of the unit print images An in which the defect has occurred.

For example, it is also possible to view an actual object of the unit print image An in which the defect has occurred to evaluate the quality of the unit print image An in which the defect has occurred, rather than viewing the image data of the unit print image An in which the defect has occurred to evaluate the quality of the unit print image An in which the defect has occurred.

It is necessary to unwind the printing medium M having been wound in a rolled form from the winding unit 25 when viewing the actual object of the unit print image An in which the defect has occurred to evaluate the quality of the unit print image An in which the defect has occurred. However, when the length of the printing medium M in an elongated form is several hundred meters, a long period of time is required to unwind the printing medium M having been wound from the winding unit 25, thus reducing an efficiency of an operation of evaluating the quality of the unit print image An in which the defect has occurred.

In the embodiment, it is not necessary to unwind the printing medium M having been wound into a rolled form from the winding unit 25 in order to evaluate the quality of the unit print image An in which the defect has occurred, thus improving the efficiency of the operation of evaluating the quality of the unit print image An in which the defect has occurred, compared to when the printing medium M having been wound into a rolled form is unwound from the winding unit 25.

For example, the CPU 51 can evaluate the quality of the unit print image An in which the defect has occurred in comparison with a reference image (ideal image).

However, the quality of the print image that is required may slightly vary depending on the user. For example, a minor unevenness may be accepted by the user, or even a minor unevenness may not be accepted by the user.

Even when the required quality is slightly different, a proficiency in quality evaluation is required in order to properly evaluate the quality of the unit print image An in which the defect has occurred. In the current state, it is difficult for the CPU 51 to completely and properly perform an evaluation of slight quality differences that requires proficiency. In the embodiment, the operator who is proficient in evaluating the quality evaluates the quality of the print image. Because the operator who is proficient evaluates the quality of the print image, the quality of the unit print image An in which the defect has occurred is completely and properly evaluated even when the required quality is slightly different.

Moreover, in the embodiment, the operator, who views the unit print image A3 in which the defect has occurred in comparison with the unit print images A2 and A4 to evaluate the quality of the unit print image An in which the defect has occurred, becomes easily able to more properly evaluate the quality of the unit print image An in which the defect has occurred, compared to when viewing only the unit print image A3 in which the defect has occurred.

The printer 1 according to the embodiment is configured to continuously form the print image on each of a plurality of the printing medium M of a single sheet (hereinafter referred to as single paper sheet), rather than continuously forming the print image on the printing medium M in an elongated form.

For example, in the printer in a comparative example, the printer is configured to continuously form the print image on each of a plurality of single paper sheets, to capture the print image formed on each of the plurality of single paper sheets, and to compare the captured image with the reference image (ideal image) to determine the captured image that deviates from the reference image as an error image. It is further possible for the operator to finally confirm the captured image of the single paper sheet having been determined as the error image, and to determine whether the quality of the print image formed on the single paper sheet is of an acceptable level or an unacceptable level. In such a configuration, a burden on the operator is abbreviated because the printer is partially responsible for a quality evaluation of the print image.

However, in the printer in the comparative example, because the printer is partially responsible for the quality evaluation of the print image and the printer determines the print image as the error image, the operator, when evaluating the quality of the captured image of the single paper sheet having been determined as the error image, easily has preconceived ideas that the single paper sheet on which the error image has been formed is abnormal, which easily causes the operator to erroneously evaluate the quality.

In the embodiment, the printer 1 detects the occurrence (defect) affecting the quality of the print image and does not evaluate the quality of the print image, and the operator evaluates the quality of the print image. That is, unlike the printer in the comparative example described above, the printer 1 according to the embodiment is not partially responsible for the quality evaluation of the print image.

Because the printer 1 is not partially responsible for the quality evaluation of the print image, the operator is inhibited from having superfluous preconceived ideas, which prevents the operator from erroneously evaluating the quality. Thus, the operator can properly evaluate the quality of the print image in a state of being inhibited from having the superfluous preconceived ideas.

The above-described embodiment may be modified as follows to be implemented. The above-described embodiment and modified examples to be described below may also be implemented in combination within a range in which a technical contradiction does not arise.

1) The above-described embodiment has a configuration in which the camera 61 that is an example of the image-capturing unit is, but not limited to, mounted on the carriage 46. A configuration may be employed in which the camera 61 that is an example of the image-capturing unit is not mounted on the carriage 46. For example, a configuration may be employed in which the camera 61 is disposed downstream in the transport direction Y of the carriage 46 (the liquid discharge head 40), and the camera 61, which is disposed downstream in the transport direction Y of the liquid discharge head 40, captures the print image (the unit print image An) formed, on the printing medium M, of the liquid that is discharged from the liquid discharge head 40.

2) In the above-described embodiment, the configuration is employed in which the storage unit 53 holds all of the image data containing the unit print image An formed at the time when the defect affecting the quality of the print image is detected. The present disclosure is not limited to this configuration.

A configuration may be employed in which the storage unit 53 holds some of the image data containing the unit print image An formed at the time when the defect affecting the quality of the print image is detected. For example, a configuration may be employed in which the storage unit 53 holds the image data containing a corresponding unit print image An when the CPU 51 determines the unit print image An as an error. Specifically, the configuration may be a configuration in which the CPU 51 learns a boundary of whether the unit print image An is determined as the error and the storage unit 53 is caused to hold only the image data containing the unit print image An having been determined as the error by the CPU 51.

3) In the above-described embodiment, the configuration is employed in which the CPU 51 that functions as the control unit configured to control the printer 1 and the controller 50 including the storage unit 53 configured to hold the image data captured by the camera 61 are built into the printer 1. The present disclosure is not limited to this configuration.

The CPU 51 that functions as the control unit configured to control the printer 1 may be disposed at an outside (a remote location) from the printer 1. For example, the CPU 51 (the controller 50) that functions as the control unit configured to control the printer 1 may be a computer that is connectable via a network.

The storage unit 53 configured to hold the image data may be disposed the outside (the remote location) from the printer 1. For example, the storage unit 53 configured to hold the image data may be an external storage that is connectable via the network.

4) In the above-described embodiment, the configuration is employed in which the immediately preceding unit print image A2 and the immediately succeeding unit print image A4 are displayed on the test screen 80 in addition to the unit print image A3 in which the defect has occurred and the operator evaluates the quality of the unit print image A3 in which the defect has occurred in comparison with the immediately preceding unit print image A2 and the immediately succeeding unit print image A4. The present disclosure is not limited to this configuration.

A configuration may be employed in which the reference image that is a limit sample of a defective product and the reference image that is a limit sample of a non-defective product are displayed on the test screen 80 in addition to the unit print image A3 in which the defect has occurred and the operator evaluates the quality of the unit print image A3 in which the defect has occurred in comparison with the reference images that are the limit samples. For example, when a boundary between the non-defective product and the defective product is ambiguous, the operator, when evaluating the quality of the unit print image A3 in which the defect has occurred in comparison with the reference images that are the limit samples, can more properly evaluate the quality of the unit print image A3 in which the defect has occurred.

What is claimed is:

1. A printer, comprising:
a printing unit configured to perform printing on a printing medium having an elongated shape;
an image-capturing unit configured to capture a print image formed, by being printed by the printing unit, on the printing medium;
a storage unit configured to store image data of the image-capturing unit; and
a winding unit configured to wind the printing medium on which printing was performed by the printing unit; and
a detection unit configured to detect a defect affecting a quality of the print image, wherein
the storage unit is configured to hold, when the defect is detected, the image data containing a unit print image formed by unit printing operation at a time when the defect is detected.

2. The printer according to claim 1, wherein
the image-capturing unit is configured to capture each of the unit print images formed by the unit printing operation, and wherein
the storage unit is configured to hold, when the defect is detected, the image data containing at least one of an immediately preceding unit print image formed by the unit printing operation immediately before the unit printing operation at the time when the defect is detected, or an immediately succeeding unit print image formed by the unit printing operation immediately after the unit printing operation at the time when the defect is detected.

3. The printer according to claim 1, wherein
the printing unit includes a carriage movable in a scanning direction,
a liquid discharge head mounted on the carriage and configured to discharge a liquid onto the printing medium, and
a transport unit configured to transport the printing medium in a direction intersecting the scanning direction, and
the image-capturing unit is not mounted on the carriage.

4. The printer according to claim 1, wherein
the printing unit includes a carriage movable in a scanning direction,
a liquid discharge head mounted on the carriage and configured to discharge a liquid onto the printing medium, and
a transport unit configured to transport the printing medium in a direction intersecting the scanning direction, and
the image-capturing unit is mounted on the carriage.

5. A control method for a printer, comprising:
capturing a print image formed on a printing medium having an elongated shape;
detecting a defect affecting a quality of the print image; and
causing the storage unit to hold, when the defect is detected, the image data containing a unit print image formed by unit printing operation at a time when the defect is detected.
